(19) United States
(12) Patent Application Publication
(10) Pub. No.: US 2026/0274081 A1
(43) Pub. Date: Sep. 17, 2026

(54) HYBRID ELECTRIC VEHICLE AND A FAULT DIAGNOSIS METHOD FOR SAME

(71) Applicants: HYUNDAI MOTOR COMPANY, Seoul (KR); KIA CORPORATION, Seoul (KR)

(72) Inventors: Min Ju Kang, Hwaseong-si (KR); Jun Haeng Heo, Hwaseong-si (KR); Jae Sung Chung, Hwaseong-si (KR); Jun Yong Park, Hwaseong-si (KR); Jun Woo Jeon, Hwaseong-si (KR); Seong Joo Kim, Hwaseong-si (KR); Kyu Hwan Jo, Hwaseong-si (KR); Seo Yeon Kim, Hwaseong-si (KR)

(73) Assignees: HYUNDAI MOTOR COMPANY, Seoul (KR); KIA CORPORATION, Seoul (KR)

(21) Appl. No.: 19/294,075

(22) Filed: Aug. 7, 2025

(30) Foreign Application Priority Data
Mar. 13, 2025 (KR) 10-2025-0032901

(51) Int. Cl. B60L 15/20

(52) U.S. Cl. CPC B60L 15/20; B60L 2240/423; B60L 2250/28

(57) ABSTRACT

Provided are a method of effectively diagnosing a vehicle fault in a belt-type or direct-type TMED hybrid electric vehicle, and a hybrid electric vehicle to which the method is applied. In a hybrid electric vehicle according to an embodiment of the present disclosure, a hybrid control unit within the vehicle may determine an upper torque limit and a lower torque limit based on APS and BPS information. The hybrid control unit may determine a reference torque range based on the upper torque limit and the lower torque limit, and may diagnose a vehicle fault by comparing the reference torque range with command torque and output torque. This enables abnormal behavior to be proactively prevented in a belt-type or direct-type TMED hybrid electric vehicle, thereby ensuring the safety of the driver, pedestrians, and other vehicle drivers and preventing vehicle damage.

### CROSS-REFERENCE TO RELATED APPLICATION

The present application claims priority to Korean Patent Application No. 10-2025-0032901 filed on Mar. 13, 2025, the entire contents of which are incorporated herein for all purposes by this reference.

### TECHNICAL FIELD

The present disclosure relates to a hybrid electric vehicle that monitors the vehicle during driving to proactively prevent abnormal behavior, and to a fault diagnosis method for the same.

### BACKGROUND

With the recent rise in environmental concerns, eco-friendly vehicles equipped with electric motors as drive sources have increased. Eco-friendly vehicles are also referred to as electrified vehicles, and may include hybrid electric vehicles (HEVs) and electric vehicles (EVs).

Of these vehicles, the hybrid electric vehicles may achieve high efficiency by selectively operating an engine and a motor depending on the driving conditions. Such hybrid electric vehicles may be classified into different types based on a connection structure of a powertrain. A powertrain configured with an engine clutch between the engine and the drive motor, and with the drive motor connected to an input end of a transmission, is referred to as a transmission mounted electric drive (TMED) type. In TMED-type hybrid electric vehicles, a hybrid starter generator (HSG) is provided for cranking to start the engine or recovering the engine's kinetic energy. The hybrid starter generator may be connected to the engine via a belt and pulley (belt-type TMED) or directly connected to the engine (direct-type TMED).

A hybrid control unit (HCU), which functions as a higher-level controller over the controllers for each drive source, determines the driver's required torque (the torque required by the driver) based on information received from an accelerator position sensor (APS) or a brake position sensor (BPS) and computes command torque for each drive source by considering the torque required for power distribution and transient control based on the control strategy. The controller for each drive source receives the command torque, controls each drive source accordingly, and determines output torque. Such command torque and output torque may be distorted due to errors in software or hardware, which may cause abnormal vehicle behavior.

The above description of the related art is intended to provide a better understanding of the background of the present disclosure and should not be taken as an admission of prior art known to those of ordinary skill in the art.

### SUMMARY

In view of the foregoing, it is required to prevent abnormal behavior of the hybrid electric vehicle during driving and ensure vehicle safety.

The present disclosure is directed to providing a method for preventing abnormal behavior of a hybrid electric vehicle and ensuring safety, and a hybrid electric vehicle to which the method is applied.

The technical subjects or aspects to be achieved in an embodiment of the present disclosure may not be limited to the above-mentioned technical subjects or aspects, and other technical subjects or aspects which are not mentioned may be clearly understood, through the following descriptions, by those having ordinary skill in the art to which the present disclosure pertains.

In an aspect of the present disclosure, a method of controlling a hybrid electric vehicle includes: determining control torque for drive source control based on position information of an accelerator pedal and a brake pedal in the hybrid electric vehicle in which an engine connected to a first motor and a second motor connected to a transmission are selectively connected via an engine clutch; determining a reference torque range based on the position information of the accelerator pedal and the brake pedal and determining a fault based on the control torque and the reference torque range.

In an embodiment of the present disclosure, the control torque may include command torque for each drive source, which is determined based on the position information of the accelerator pedal and the brake pedal, and output torque of each drive source generated based on the command torque for each drive source.

In an embodiment of the present disclosure, determining the control torque may include determining a first torque corresponding to an acceleration component, a second torque for simulating creep torque based on vehicle speed, and a third torque corresponding to a deceleration component, respectively.

In an embodiment of the present disclosure, determining the reference torque range may include determining the first torque, the second torque, and the third torque, respectively, determining an upper torque limit in the reference torque range based on the first torque and the second torque, and determining a lower torque limit in the reference torque range based on the second torque and the third torque.

In an embodiment of the present disclosure, determining the upper torque limit and the lower torque limit may be performed by further being based on an operating point adjustment torque for adjusting the operating point based on efficiency of the drive source, and a transient control torque based on drivability of the vehicle.

In an embodiment of the present disclosure, the operating point adjustment torque and the transient control torque may be determined based on the engine torque (i.e., torque of the engine), the first motor torque (i.e., torque of the first motor), and the second motor torque (i.e., torque of the second motor)under a condition in which the engine clutch is engaged. The operating point adjustment torque and the transient control torque may be determined based on the second motor torque under a condition in which the engine clutch is open.

In an embodiment of the present disclosure, determining the fault based on the control torque and the reference torque range may be performed based on the engine torque, the first motor torque, the second motor torque, and the reference torque range under a condition in which the engine clutch is engaged, and performed based on the second motor torque and the reference torque range under a condition in which the engine clutch is open.

In an embodiment of the present disclosure, determining the fault may include determining the vehicle as being in a fault state based on the control torque falling or being outside the reference torque range.

In an embodiment of the present disclosure, the first motor may be connected to the engine via a belt and a pulley, or directly connected to the engine.

In an embodiment of the present disclosure, determining the upper torque limit and the lower torque limit may be performed by further being based on an operating point adjustment torque, a transient control torque, and an assist torque of the first motor under a condition in which the first motor is connected to the engine via a belt and a pulley. Further, determining the upper torque limit and the lower torque limit may be performed by further being based on the operating point adjustment torque and the transient control torque under a condition in which the first motor is directly connected to the engine.

In an embodiment of the present disclosure, the method may further include determining a connection type of the first motor to the engine prior to or before determining the control torque.

In another aspect of the present disclosure, a hybrid electric vehicle may include: a powertrain in which an engine connected to a first motor and a second motor connected to a transmission are selectively connected via an engine clutch, and a first controller. The first controller is configured to determine command torque for each drive source and a reference torque range for controlling the powertrain based on position information of an accelerator pedal and a brake pedal of the vehicle, and to determine a fault based on the command torque for each drive source and the reference torque range.

In an embodiment of the present disclosure, the hybrid electric vehicle may further include a second controller configured to control each drive source of the powertrain based on the command torque, and to determine output torque of each drive source generated by each respective drive source as a result of the control (i.e., controlling each drive source of the powertrain based on the command torque). The first controller may be further configured to determine a fault based on the output torque of each drive source and the reference torque range.

In an embodiment of the present disclosure, the first controller may be further configured to determine a first torque corresponding to an acceleration component, a second torque for simulating creep torque based on vehicle speed, and a third torque corresponding to a deceleration component, respectively.

In an embodiment of the present disclosure, the first controller may be further configured to determine an upper torque limit in the reference torque range based on the first torque and the second torque, and determine a lower torque limit in the reference torque range based on the second torque and the third torque.

In an embodiment of the present disclosure, the first controller may be further configured to determine the upper torque limit and the lower torque limit by further being based on an operating point adjustment torque for adjusting the operating point based on efficiency of the drive source, and a transient control torque based on drivability of the vehicle.

In an embodiment of the present disclosure, the first controller may be further configured to: determine the operating point adjustment torque and the transient control torque based on the engine torque, the first motor torque, and the second motor torque under a condition in which the engine clutch is engaged; and determine the operating point adjustment torque and the transient control torque based on the second motor torque under a condition in which the engine clutch is open.

In an embodiment of the present disclosure, the first controller may be further configured to: determine a fault based on the engine torque, the first motor torque, the second motor torque, and the reference torque range under a condition in which the engine clutch is engaged; and determine a fault based on the second motor torque and the reference torque range under a condition in which the engine clutch is open.

In an embodiment of the present disclosure, the first controller may be configured to determine the vehicle as being in a fault state based on the control torque falling or being outside the reference torque range.

With at least one embodiment of the present disclosure, monitoring command torque and output torque during driving of a belt-type or direct-type transmission mounted electric drive (TMED) hybrid electric vehicle allows for proactive prevention of abnormal vehicle behavior, thereby ensuring the safety of the driver, pedestrians, and other vehicle drivers, and preventing vehicle damage.

The effects of the present disclosure are not limited to those mentioned above. Other unmentioned effects should be clearly understood by those having ordinary skill in the art from the description below.

### BRIEF DESCRIPTION OF THE DRAWINGS

FIG. 1 shows an example of a powertrain configuration of a direct-type transmission mounted electric drive (TMED) hybrid electric vehicle according to an embodiment of the present disclosure.

FIG. 2 shows an example of a powertrain configuration of a belt-type TMED hybrid electric vehicle according to an embodiment of the present disclosure.

FIG. 3 shows an example of a control system configuration of a hybrid electric vehicle according to an embodiment of the present disclosure.

FIG. 4 is a flowchart showing an example of a process in which a hybrid control unit determines command torque and output torque for each drive source.

FIG. 5 is a flowchart showing an example of a process in which a hybrid control unit determines an upper torque limit.

FIG. 6 is a flowchart showing an example of a process in which a hybrid control unit determines a lower torque limit.

FIG. 7 is a flowchart showing an example of a process in which a vehicle fault is diagnosed based on the determined upper torque limit and lower torque limit.

### DETAILED DESCRIPTION

Hereinafter, embodiments disclosed in the present specification are described in detail with reference to the drawings. The same reference numerals are given to the same or similar components regardless of reference numerals, and a repetitive description thereof has been omitted. As used in the following description, suffixes “module” and “part” for a component are used or interchangeably used solely for ease of preparation of the specification, and do not have different meanings and each of them does not function by itself. In describing embodiments disclosed in the present specification, when a detailed description of a known related art is determined to obscure the gist of embodiments disclosed in the present specification, the detailed description thereof has been omitted herein. In addition, the accompanying drawings are merely for easy understanding of embodiments disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as “first,” “second,” and the like used herein may be used to describe various components, but the various components are not limited by these terms. The terms are used only for the purpose of distinguishing one component from another component.

When a component is referred to as being “connected” or “coupled” to another component, the component may be directly connected or coupled to another component, but it should be understood that sill another component may be present between the component and another component. Conversely, when a component is referred to as being “directly connected” or “directly coupled” to another component, it should be understood that still another component may not be present between the component and another component.

Unless the context clearly dictates otherwise, the singular form includes the plural form.

In the present specification, it should be understood that the terms “comprising,” “having,” “including,” or the like are used to specify that a feature, a number, a step, an operation, a component, an element, or a combination thereof described herein exists, and they do not preclude the possibility of the presence or addition of one or more other features, numbers, steps, operations, components, elements, or combinations thereof.

When a component, processor, controller, device, element, apparatus, or the like of the present disclosure is described as having a purpose or performing an operation, function, or the like, the component, processor, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof. In addition, a unit or control unit included in names such as a motor control unit (MCU) is only a term widely used in the naming of a controller that controls the specific function of a vehicle, but does not mean a generic function unit. A control unit may include a communication device for communicating with other control units or sensors to control a responsible function, memory for storing an operating system, a logic command, and input/output information, and one or more processors for performing determination, calculation, and decision which are necessary for controlling the responsible function.

Prior to describing a fault diagnosis method according to embodiments of the present disclosure, a structure and control system of a hybrid electric vehicle relevant to embodiments are described.

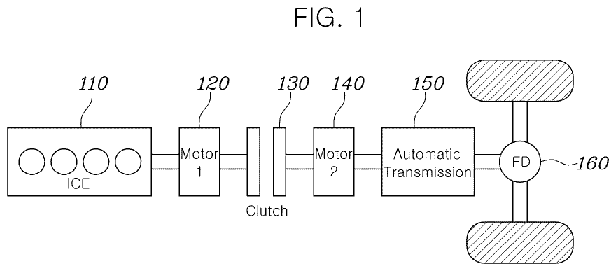

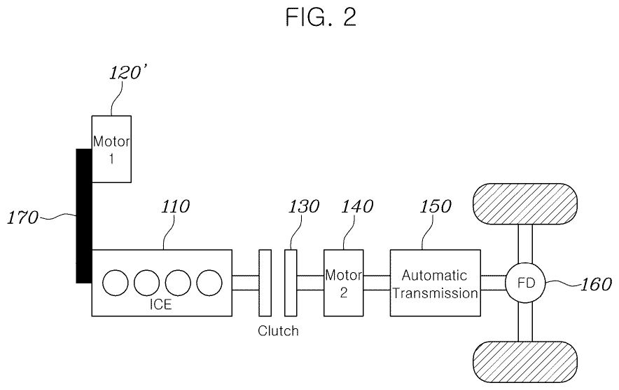

FIG. 1 shows an example of a powertrain configuration of a direct-type transmission mounted electric drive (TMED) hybrid electric vehicle according to an embodiment of the present disclosure. FIG. 2 shows an example of a powertrain configuration of a belt-type TMED hybrid electric vehicle according to an embodiment of the present disclosure.

With reference to FIG. 1, the powertrain of a direct-type TMED hybrid electric vehicle is shown, which employs a parallel-type hybrid system equipped with two motors 120 and 140 and an engine clutch 130 installed between an internal combustion engine (ICE) 110 and a transmission 150.

In this configuration, a first motor 120 of the two motors 120 and 140 may be disposed between the ICE 110 and an end of the engine clutch 130, and an engine shaft of the ICE 110 and a first motor shaft of the first motor 120 may be directly connected to each other and constantly rotate together.

In FIG. 1, the first motor 120 is shown as being disposed between the ICE 110 and the engine clutch 130. However, depending on the implementation, the ICE 110 may be disposed between the first motor 120 and the engine clutch 130. Even in this configuration, the ICE 110 remains directly connected to the first motor 120 without change.

With reference to FIG. 2, the powertrain of a belt-type TMED hybrid electric vehicle is shown, in which the engine clutch 130 and a second motor 140 are installed between the internal combustion engine (ICE) 110 and the transmission 150, and the ICE 110 and a first motor 120′ are connected via a belt and pulley 170.

In this configuration, the first motor 120′ of the two motors 120′ and 140 may be connected to the ICE 110 via the belt and pulley 170. The engine shaft of the ICE 110 may be connected to one end of the engine clutch 130, and the other end of the engine clutch 130 may be connected to one end of the second motor 140. In addition, the other end of the second motor 140 may be connected to an input end of the transmission 150.

For convenience in describing the structure and control system of a hybrid electric vehicle below, a direct-type TMED hybrid electric vehicle is considered and described with reference to FIG. 1.

One end of a second motor shaft of the second motor 140 may be connected to the other end of the engine clutch 130, and the other end of the second motor shaft may be connected to an input end of the transmission 150.

The second motor 140 may have a higher output compared to the first motor 120. The second motor 140 may serve as a drive motor. In addition, the first motor 120 may function as a starting motor by cranking the ICE 110 during engine startup. In the engine-off state, the first motor 120 may recover the rotational energy of the ICE 110 through power generation. In the engine-running state, the first motor 120 may also perform power generation using power from the ICE 110.

In a hybrid electric vehicle equipped with the powertrain shown in FIG. 1, if a driver presses an accelerator pedal after startup (e.g., hybrid electric vehicle (HEV) Ready), the second motor 140 may be first driven using power from a battery (not shown) under a condition in which the engine clutch 130 is open. Accordingly, power from the second motor 140 is transmitted through the transmission 150 and a final drive (FD) 160 to move driving wheels (i.e., electric vehicle (EV) mode). As the vehicle gradually accelerates and requires progressively more driving force, the first motor 120 operates to crank the ICE 110.

If the difference in rotational speed between the ICE 110 and the second motor 140 falls within a certain range after the ICE 110 starts, the engine clutch 130 may engage, allowing the ICE 110 and the second motor 140 to rotate together (i.e., transition from EV mode to HEV mode). Accordingly, through a torque blending process, the output of the second motor 140 decreases, and the output of the ICE 110 increases, thereby satisfying the driver's required torque. In HEV mode, the ICE 110 may satisfy most of the required torque, and at least one of the first motor 120 and the second motor 140 may compensate for the difference between the engine torque and the required torque. For example, considering the efficiency of the ICE 110, if the ICE 110 outputs torque higher than the required torque, either the first motor 120 or the second motor 140 generates power to compensate for the excess engine torque. If the engine torque is insufficient compared to the required torque, at least one of the first motor 120 and the second motor 140 may output the insufficient torque.

If the predetermined engine-off conditions, such as deceleration of the vehicle, are satisfied, the engine clutch 130 may open, and the ICE 110 may stop (i.e., transition from HEV mode to EV mode). During deceleration, the second motor 140 may charge the battery by utilizing the driving force of the wheels, which is referred to as brake energy regeneration, or regenerative braking.

In general, the transmission 150 may be a stepped transmission or a multi-plate clutch, for example, a dual-clutch transmission (DCT).

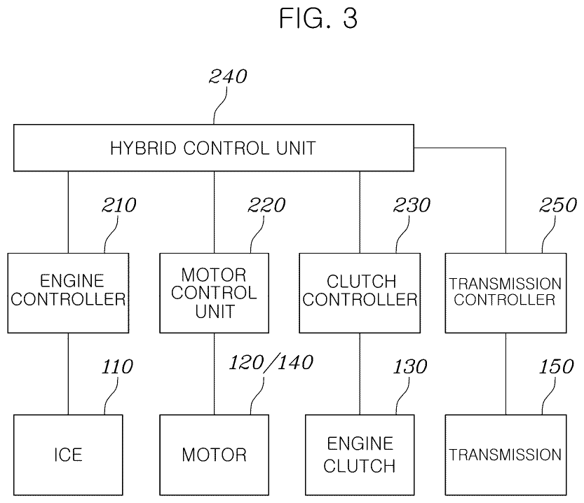

FIG. 3 shows an example of a control system configuration of a hybrid electric vehicle according to an embodiment of the present disclosure.

With reference to FIG. 3, in a hybrid electric vehicle to which embodiments of the present disclosure may be applied, the ICE 110 may be controlled by an engine controller 210, the torque of the first motor 120 and the second motor 140 may be controlled by a motor controller (i.e., motor control unit, MCU) 220, and the engine clutch 130 may be controlled by a clutch controller 230. In this configuration, the engine controller 210 is also referred to as an engine management system (EMS). In addition, the transmission 150 may be controlled by a transmission controller 250.

The motor control unit 220 may control a gate drive unit (not shown) using a control signal in the form of pulse width modulation (PWM) based on motor angle, phase voltage, phase current, and required torque of each motor 120 and 140, and the gate drive unit may control an inverter (not shown), which drives each motor 120 and 140 accordingly.

Each controller may be connected to a hybrid controller (i.e., hybrid control unit, HCU) 240, which is a higher-level controller controlling the overall powertrain, including mode transition processes. Under the control of the hybrid control unit 240, each controller may provide the hybrid control unit 240 with information required for changing driving mode, controlling the engine clutch during gear shifting, and controlling engine stop or perform operations based on control signals.

For example, the hybrid control unit 240 may determine whether to perform a transition between EV-HEV modes or Charge Depleting (CD)-Charge Sustaining (CS) modes (for Plug-in Hybrid Electric Vehicles (PHEVs)) based on the vehicle's operating state. To this end, the hybrid control unit 240 may determine the timing for opening the engine clutch 130 and perform hydraulic control during the opening. In addition, the hybrid control unit 240 may determine the state of the engine clutch 130 (lock-up, slip, open, and the like) and control the timing for interrupting fuel injection of the ICE 110. In addition, the hybrid control unit 240 may transmit a torque command to the motor control unit 220 to control the torque of the first motor 120 for engine stop control, thereby controlling the recovery of engine rotational energy. In addition, the hybrid control unit 240 may determine the state of each drive source 110, 120 and 140 to satisfy the required torque, accordingly determine the required driving force to be allocated to each drive source 110, 120 and 140, and transmit a torque command to the controllers 210 and 220 for controlling each drive source.

This concludes the description of the embodiments of the structure and control system of a hybrid electric vehicle. As an embodiment of the present disclosure, a process is described below in which the hybrid control unit 240 determines a reference torque range (also referred to as “a normal torque range”) as a criterion for diagnosing a vehicle fault based on information received from an accelerator position sensor (APS) and a brake position sensor (BPS), and diagnoses the vehicle fault by comparing this normal torque range with command torque and output torque. For convenience in the description, the diagnostic process below is considered to be performed by the hybrid control unit 240. However, this is provided merely as an example, and it should be apparent to those having ordinary skill in the art that the diagnostic process may be performed by another controller or by one or more controllers.

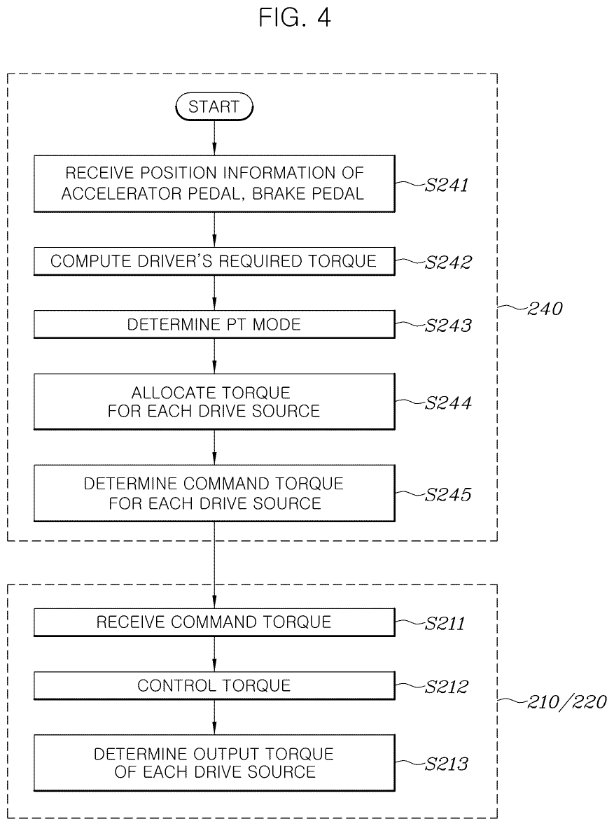

FIG. 4 is a flowchart showing an example of a process in which a hybrid control unit determines command torque and output torque for each drive source.

With reference to FIG. 4, in response to the driver's operation of the accelerator pedal or brake pedal, the hybrid control unit 240 may receive position information of the accelerator pedal through the APS or position information of the brake pedal through the BPS (S241). The hybrid control unit 240 may compute the driver's required torque based on the received information (S242) and determine a powertrain (PT) mode based on the magnitude of the driver's required torque (S243). For example, the hybrid control unit 240 may determine that in a low-speed driving condition with a small amount of driver's required torque, the vehicle operates in EV mode, in which the engine clutch 130 is disengaged, and the torque of the second motor 140 alone is used as a drive source. In contrast, in a high-speed driving condition with a large amount of driver's required torque, the hybrid control unit 240 may determine that the vehicle operates in HEV mode, in which the engine clutch 130 is engaged, and the torque of the second motor 140 and the ICE 110 is used as a drive source.

Following the determination of the powertrain mode, the hybrid control unit 240 may divide the driver's required torque into accelerator torque (i.e., first torque), creep torque (i.e., second torque) which is determined based on vehicle speed to simulate the behavior of an internal combustion engine, and regenerative torque (i.e., third torque) for regenerative braking, and allocate the accelerator torque, creep torque, and regenerative torque to each drive source (S244). Furthermore, the hybrid control unit 240 may determine command torque for each drive source by further considering operation point adjustment torque for adjusting the vehicle's operating point based on the efficiency of each drive source, and transient control torque for ensuring a stable transition from a transient state to a steady state (S245).

The engine controller 210 receives engine command torque from the command torque for each drive source (S211), controls the ICE 110 (S212), and determines the resulting engine output torque (S213). Similarly, the motor control unit 220 receives motor command torque (S211), controls the motor 120 (S212), and determines the motor output torque (S213).

However, diagnosing a vehicle fault is not based on whether the total of the command torque and output torque for each drive source falls within the normal torque range. A detailed description of the vehicle fault diagnosis process based on command torque and output torque is provided below.

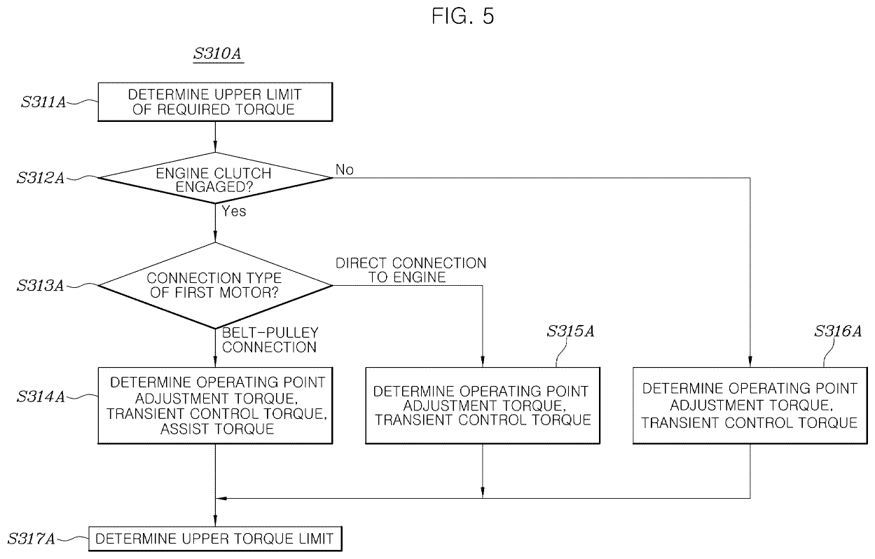

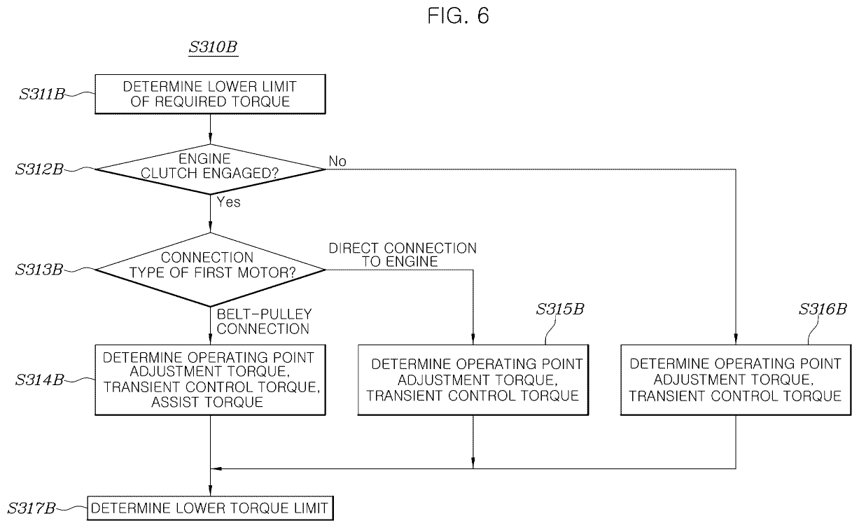

FIG. 5 is a flowchart showing an example of a process in which a hybrid control unit determines an upper torque limit. FIG. 6 is a flowchart showing an example of a process in which a hybrid control unit determines a lower torque limit.

With reference to FIGS. 5 and 6, the hybrid control unit 240 may determine an upper torque limit and a lower torque limit to determine a normal or reference torque range based on APS and BPS information through a monitoring system independent of the system (S241 to S245) that determines command torque for each drive source. More specifically, the hybrid control unit 240 may determine the accelerator torque, regenerative torque, and creep torque based on APS and BPS information, respectively. The hybrid control unit 240 may determine an upper limit of required torque based on the accelerator torque and the creep torque from the above torque (S311A), and a lower limit of required torque based on the regenerative torque and the creep torque (S311B).

The hybrid control unit 240 may first determine whether the engine clutch 130 is engaged in order to determine an upper torque limit and a lower torque limit from the upper limit of required torque and the lower limit of required torque (S312A, S312B).

If the engine clutch 130 is engaged, the ICE 110 and the first motor 120 are connected to the transmission 150. Accordingly, the hybrid control unit 240 may determine operating point adjustment torque and transient control torque based on engine torque, first motor torque, and second motor torque (Yes in S312A and Yes in S312B). At this point, the hybrid control unit 240 may determine a TMED type, which is a connection type of the first motor in the vehicle (S313A, S313B). If the vehicle is determined to be a belt-type TMED, the hybrid control unit 240 may determine the operating point adjustment torque and transient control torque based on the engine torque and the second motor torque and may further consider assist torque of the first motor (S314A, S314B). On the other hand, if the vehicle is determined to be a direct-type TMED, the hybrid control unit 240 may determine the operating point adjustment torque and transient control torque based on the engine torque, first motor torque, and second motor torque (S315A, S315B). Such operating point adjustment torque, transient control torque, and assist torque may be collectively referred to as additional function torque.

If the engine clutch 130 is disengaged (No in S312A and S312B), the ICE 110 and the first motor 120 are separated from the transmission 150. Accordingly, the hybrid control unit 240 may determine operating point adjustment torque and transient control torque based on the second motor torque (S316A, S316B).

The hybrid control unit 240 may determine an upper torque limit based on the previously determined upper limit of required torque, operating point adjustment torque, transient control torque, and assist torque, and determine a lower torque limit based on the lower limit of required torque, operating point adjustment torque, transient control torque, and assist torque (S317A, S317B).

In summary, the hybrid control unit 240 may determine the upper torque limit based on the upper limit of required torque and additional function torque, and determine the lower torque limit based on the lower limit of required torque and additional function torque. Depending on the engagement status of the engine clutch 130 and the TMED type, which drive source's torque is used to determine the additional function torque may be summarized as shown in Table 1 below.

TABLE 1

| | | | | |
|---|---|---|---|---|
| | | Operating | | |
| | | Point | Transient | |
| Engine Clutch | TMED | Adjustment | Control | Assist |
| Engagement | Type | Torque | Torque | Torque |

| | | | |
|---|---|---|---|
| Engaged | Belt | 2^{nd} motor torque, | 1^{st} motor |
| | | engine torque | torque |
| | Direct | 1^{st} motor torque, 2^{nd} motor | |
| | | torque, engine torque | |
| Disengaged | Irrelevant | 2^{nd} motor torque | |

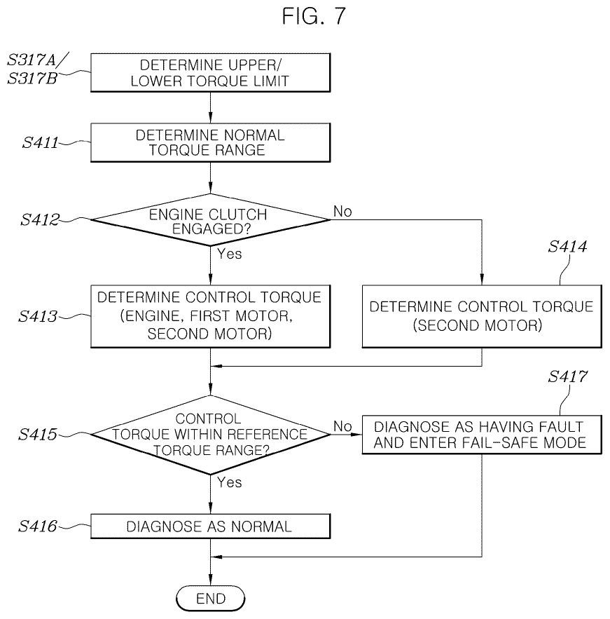

FIG. 7 is a flowchart showing an example of a process in which a vehicle fault is diagnosed based on the determined upper torque limit and lower torque limit.

FIG. 7 is considered to show a subsequent process following the processes shown in FIGS. 5 and 6.

With reference to FIG. 7, the hybrid control unit 240 may determine a normal torque range based on the determined upper torque limit and lower torque limit (S317A, S317B) (S411) and compare the determined normal torque range with control torque (collectively refers to command torque and output torque).

If the engine clutch 130 is engaged (Yes in S412), the hybrid control unit 240 may determine whether the total control torque, based on the engine torque, first motor torque, and second motor torque from the control torque for each drive source, falls within a normal (i.e., reference) torque range (S413, S415). On the other hand, if the engine clutch 130 is disengaged (No in S412), the hybrid control unit 240 may determine whether the second motor torque from the control torque for each drive source falls within the normal torque range (S414, S415).

If the control torque falls within the normal torque range (Yes in S415), the hybrid control unit 240 may diagnose the vehicle as being in a normal state. However, if the control torque falls outside the normal torque range (No in S415), the hybrid control unit 240 may diagnose the vehicle as having a fault (S416) and allow the vehicle to enter a fail-safe mode as needed.

Although the specific embodiments of the present disclosure have been described and illustrated, those having ordinary skill in the art should appreciate that various alternations and modifications are possible without departing from the technical spirit of the present disclosure provided in the appended claims.

What is claimed is:

1. A method of controlling a hybrid electric vehicle, the method comprising:
determining control torque for drive source control based on position information of an accelerator pedal and a brake pedal in the hybrid electric vehicle in which an engine connected to a first motor and a second motor connected to a transmission are selectively connected via an engine clutch, wherein each of the engine, the first motor, and the second motor is a drive source;
determining a reference torque range based on the position information of the accelerator pedal and the brake pedal;
determining a fault based on the control torque and the reference torque range; and
controlling each drive source based on the control torque.

2. The method of claim 1, wherein the control torque includes:
command torque for each drive source, wherein the command torque is determined based on the position information of the accelerator pedal and the brake pedal; and
output torque of each drive source generated based on the command torque for each drive source.

3. The method of claim 1, wherein determining the control torque includes determining a first torque corresponding to an acceleration component, a second torque for simulating creep torque based on vehicle speed, and a third torque corresponding to a deceleration component, respectively.

4. The method of claim 3, wherein determining the reference torque range includes:
determining the first torque, the second torque, and the third torque, respectively;
determining an upper torque limit in the reference torque range based on the first torque and the second torque; and
determining a lower torque limit in the reference torque range based on the second torque and the third torque.

5. The method of claim 4, wherein determining the upper torque limit and the lower torque limit is performed by further being based on an operating point adjustment torque for adjusting the operating point based on efficiency of each drive source, and a transient control torque based on drivability of the vehicle.

6. The method of claim 5, wherein the operating point adjustment torque and the transient control torque are determined based on a torque of the engine, a torque of the first motor, and a torque of the second motor under a condition in which the engine clutch is engaged, and
wherein the operating point adjustment torque and the transient control torque are determined based on the torque of second motor under a condition in which the engine clutch is open.

7. The method of claim 4, wherein determining the upper torque limit and the lower torque limit is performed by further being based on an operating point adjustment torque, a transient control torque, and an assist torque of the first motor under a condition in which the first motor is connected to the engine via a belt and a pulley, and
wherein determining the upper torque limit and the lower torque limit is performed by further being based on the operating point adjustment torque and the transient control torque under a condition in which the first motor is directly connected to the engine.

8. The method of claim 1, wherein determining the fault based on the control torque and the reference torque range is performed based on torque of the engine, torque of the first motor, torque of the second motor, and the reference torque range under a condition in which the engine clutch is engaged, and
wherein determining the fault based on the control torque and the reference torque range is performed based on the second motor torque and the reference torque range under a condition in which the engine clutch is open.

9. The method of claim 1, wherein determining the fault includes determining the vehicle as being in a fault state based on the control torque being outside the reference torque range.

10. The method of claim 1, wherein the first motor is connected to the engine via a belt and a pulley, or directly connected to the engine.

11. The method of claim 1, further comprising:
determining a connection type of the first motor to the engine before determining the control torque.

12. A hybrid electric vehicle comprising:
a powertrain in which an engine connected to a first motor and a second motor connected to a transmission are selectively connected via an engine clutch, wherein each of the engine, the first motor, and the second motor is a drive source; and
a first controller configured to
determine a command torque for each drive source and a reference torque range for controlling the powertrain based on position information of an accelerator pedal and a brake pedal of the vehicle, and
determine a fault based on the command torque for each drive source and the reference torque range.

13. The hybrid electric vehicle of claim 12, further comprising a second controller configured to:
control each drive source of the powertrain based on the command torque; and
determine an output torque of each drive source generated by each respective drive source as a result of controlling each drive source of the powertrain based on the command torque,
wherein the first controller is further configured to determine the fault based on the output torque of each drive source and the reference torque range.

14. The hybrid electric vehicle of claim 12, wherein the first controller is further configured to determine a first torque corresponding to an acceleration component, a second torque for simulating creep torque based on vehicle speed, and a third torque corresponding to a deceleration component, respectively.

15. The hybrid electric vehicle of claim 14, wherein the first controller is further configured to determine an upper torque limit in the reference torque range based on the first torque and the second torque, and determine a lower torque limit in the reference torque range based on the second torque and the third torque.

16. The hybrid electric vehicle of claim 15, wherein the first controller is further configured to determine the upper torque limit and the lower torque limit by further being based on an operating point adjustment torque for adjusting the operating point based on efficiency of each drive source, and a transient control torque based on drivability of the vehicle.

17. The hybrid electric vehicle of claim 16, wherein the first controller is further configured to:
determine the operating point adjustment torque and the transient control torque based on a torque of the engine, a torque of the first motor, and a torque of the second motor under a condition in which the engine clutch is engaged; and
determine the operating point adjustment torque and the transient control torque based on the torque of the second motor under a condition in which the engine clutch is open.

18. The hybrid electric vehicle of claim 12, wherein the first controller is further configured to:
determine the fault based on torque of the engine, torque of the first motor, torque of the second motor, and the reference torque range under a condition in which the engine clutch is engaged; and
determine the fault based on the second motor torque and the reference torque range under a condition in which the engine clutch is open.

19. The hybrid electric vehicle of claim 12, wherein the first controller is further configured to determine the vehicle as being in a fault state based on the control torque being outside the reference torque range.
